(19) United States
(12) Patent Application Publication
(10) Pub. No.: US 2019/0309675 A1
(43) Pub. Date: Oct. 10, 2019

(54) INTERCOOLER AND METHOD FOR MANUFACTURING INTERCOOLER

(71) Applicant: DENSO CORPORATION, Kariya-city (JP)

(72) Inventor: Koki NISHIYAMA, Kariya-city (JP)

(21) Appl. No.: 16/449,494

(22) Filed: Jun. 24, 2019

Related U.S. Application Data
(63) Continuation of application No. PCT/JP2017/041350, filed on Nov. 16, 2017.

(30) Foreign Application Priority Data
Dec. 26, 2016 (JP) 2016-251185

(51) Int. Cl. F02B 29/04; F02M 31/20; F02D 23/00; F28D 9/00

(52) U.S. Cl. CPC F02B 29/0406; F28D 9/0056; F02D 23/00; F02M 31/20

(57) ABSTRACT

An intercooler cools supercharged intake air supplied to an internal combustion engine via a supercharger. The intercooler includes a laminated core that includes cooling tubes laminated in a tube lamination direction, and a communication pipe that is disposed on one side of the laminated core in the tube lamination direction and communicates with the cooling tubes. Cooling fluid exchanging heat with the supercharged intake air flows through the cooling tubes. The communication pipe includes a flat pipe portion connected to the cooling tubes. The flat pipe portion has a flat cross-sectional shape extending in a direction crossing the tube lamination direction.

### CROSS REFERENCE TO RELATED APPLICATION

The present application is a continuation application of International Patent Application No. PCT/JP2017/041350 filed on Nov. 16, 2017, which designated the U.S. and claims the benefit of priority from Japanese Patent Application No. 2016-251185 filed on Dec. 26, 2016. The entire disclosures of all of the above applications are incorporated herein by reference.

### TECHNICAL FIELD

The present disclosure relates to an intercooler for cooling supercharged intake air supplied to an internal combustion engine via a supercharger, and to a method for manufacturing the intercooler.

### BACKGROUND

A general intercooler includes a duct through which supercharged intake air flows, and a laminated core accommodated inside the duct. The laminated core is constituted by a plurality of cooling tubes laminated in a tube lamination direction.

There are further provided, on one side of the laminated core in a tube lamination direction, a pipe as a cooling water inlet through which cooling water is introduced into the cooling tubes, and a pipe as a cooling water outlet through which cooling water is discharged from the cooling tubes.

### SUMMARY

An intercooler according to an aspect of the present disclosure for cooling supercharged intake air supplied to an internal combustion engine via a supercharger includes: a laminated core that includes a plurality of cooling tubes laminated in a tube lamination direction; and a communication pipe disposed on one side of the laminated core in the tube lamination direction and communicating with the plurality of cooling tubes. Cooling fluid that exchanges heat with the supercharged intake air flows through the plurality of cooling tubes, the communication pipe includes a flat pipe portion connected to the plurality of cooling tubes, and the flat pipe portion has a flat cross-sectional shape extending in a direction crossing the tube lamination direction.

According to another aspect of the present discloser, a method for manufacturing an intercooler that includes a laminated core that includes a plurality of cooling tubes laminated in a tube lamination direction, cooling fluid flowing through the plurality of cooling tubes, the cooling fluid exchanging heat with supercharged intake air supplied to an internal combustion engine via a supercharger, the laminated core cooling the supercharged intake air by heat exchange between the supercharged intake air and the cooling fluid; and a duct that defines a duct passage through which the supercharged intake air flows from one side to another side in a duct direction crossing the tube lamination direction, the duct passage accommodating the laminated core, the method includes: preparing the duct; preparing a communication pipe that extends in a pipe extension direction and includes a flat pipe portion having a flat cross-sectional shape, a pipe end portion disposed on one side in the pipe extension direction with respect to the flat pipe portion and connected to an external pipe member, and a pipe joining portion located between the flat pipe portion and the pipe end portion in the pipe extension direction; preparing a laminated member that is a plate member having a brazing material on both sides and includes a laminated plate portion, and a supporting portion formed integrally with the laminated plate portion; laminating the communication pipe, the laminated member, and the duct such that the pipe extension direction crosses the tube lamination direction and the duct direction, the flat pipe portion communicates with the plurality of cooling tubes through a duct communication hole of the duct, the flat pipe portion is disposed on one side of the laminated plate portion in the tube lamination direction, a duct joining portion of the duct surrounding the duct communication hole is disposed on another side of the laminated plate portion in the tube lamination direction; and after the laminating, bonding the pipe joining portion to the supporting portion, and the flat pipe portion to the duct joining portion through the laminated plate portion by temporarily heating the duct, the communication pipe, and the laminated member to braze with

### BRIEF DESCRIPTION OF THE DRAWINGS

FIG. 1 is a perspective view schematically illustrating mounting positions of an intercooler and others in a vehicle according to at least one embodiment, transparently showing the intercooler and others inside a front engine room as viewed from a front side of the vehicle.

FIG. 2 is a schematic view illustrating mounting positions of the intercooler and others with respect to an engine in at least one embodiment, showing an interior of the front engine room as viewed in a direction of an arrow II in FIG. 1.

FIG. 3 is a perspective view of the intercooler in at least one embodiment.

FIG. 4 is a front view of the intercooler illustrated in FIG. 3.

FIG. 5 is a plan view of the intercooler illustrated in FIG. 3.

FIG. 6 is an exploded perspective view of the intercooler illustrated in FIG. 3.

FIG. 7 is a perspective view illustrating, as a single unit, a first plate which is a component constituting a duct of the intercooler shown in FIG. 3.

FIG. 8 is a perspective view illustrating, as a single unit, a second plate which is a component constituting the duct of the intercooler shown FIG. 3.

FIG. 9 is a perspective view schematically illustrating a configuration of a laminated core of the intercooler shown in FIG. 3, showing a partially cutaway part of the duct.

FIG. 10 is a cross-sectional view illustrating a junction portion between the intercooler and an external pipe member in at least one embodiment, showing both an inlet side and an outlet side of a duct passage.

FIG. 11 is a cross-sectional view illustrating a cross section taken along a line XI-XI in FIG. 5.

FIG. 12 is a cross-sectional view taken along a line XII-XII in FIG. 11, showing an outlet pipe of the intercooler as a single unit.

FIG. 13 is a view of a portion XIII extracted from FIG. 11, an exploded view showing the outlet pipe and a cap separated from each other.

FIG. 14 is a front view illustrating a laminated member in FIG. 11 as a single member, showing the laminated member as viewed from one side in a tube lamination direction.

FIG. 15 is a view in a direction of an arrow XV in FIG. 14, showing the laminated member as viewed from one side in a pipe extension direction.

FIG. 16 is a view in a direction of an arrow XVI in FIG. 14, showing the laminated member as viewed from the other side in the pipe extension direction.

FIG. 17 is a flowchart showing manufacturing steps of the intercooler according to at least one embodiment.

FIG. 18 is a schematic view illustrating mounting positions of an intercooler and others with respect to an engine in a comparative example compared with at least one embodiment, and corresponds to FIG. 2 of at least one embodiment.

FIG. 19 is a view of a XIII portion extracted from FIG. 11 in at least one embodiment, an exploded view corresponding to FIG. 13 of at least one embodiment.

FIG. 20 is a view of the XIII portion extracted from FIG. 11 in at least one embodiment, exploded view corresponding to FIG. 13 of at least one embodiment.

FIG. 21 is a view of the XIII portion extracted from FIG. 11 in at least one embodiment, corresponding to FIG. 13 of at least one embodiment.

FIG. 22 is a view of the XIII portion extracted from FIG. 11 in at least one embodiment, corresponding to FIG. 13 of at least one embodiment.

FIG. 23 is a view of the XIII portion extracted from FIG. 11 in at least one embodiment, corresponding to FIG. 13 of at least one embodiment.

### EMBODIMENTS

Respective embodiments are hereinafter described with reference to the drawings. In the respective embodiments described herein, identical or equivalent parts are given identical reference numerals in the figures.

### First Embodiment

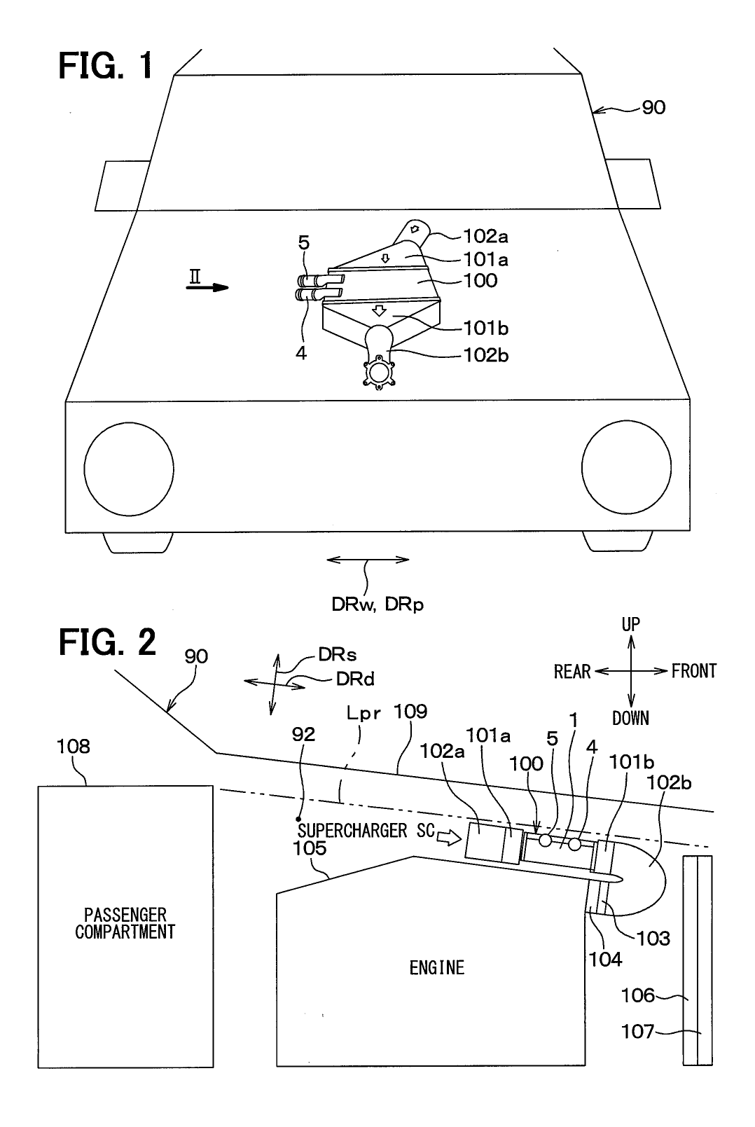

A first embodiment is hereinafter described. As illustrated in FIGS. 1 and 2, an intercooler 100 according to the present embodiment is disposed inside a front engine room 92 (hereinafter simply referred to as “engine room 92”) of a vehicle 90. FIG. 1 is a view transparently illustrating the intercooler 100 and others inside the engine room 92 as viewed from a front side of the vehicle 90. FIG. 2 is a diagram illustrating an arrangement of the intercooler 100, an engine 105, and others when an interior of the engine room 92 is viewed in a width direction of the vehicle 90.

The intercooler 100 of the present embodiment is a heat exchanger which cools supercharged intake air (hereinafter also simply referred to as “intake air”) supplied to the engine 105 via a supercharger SC. More specifically, the intercooler 100 cools intake air by heat exchange between cooling fluid for cooling and the intake air having a high temperature after pressurization by the supercharger SC.

A first gas tank 101a is connected to an air flow upstream side of the intercooler 100. A first intake pipe 102a is connected to an air flow upstream side of the first gas tank 101a. Intake air having a high temperature after pressurization by the supercharger SC passes through the first intake pipe 102a and the first gas tank 101a in this order, and passes inside the intercooler 100.

The intake air passing inside the intercooler 100 is cooled by heat exchange with cooling fluid. The cooling fluid is constituted by LLC, for example. LLC is an abbreviation of long life coolant. According to the present embodiment, the cooling fluid is a liquid, wherefore the intercooler 100 is a water-cooled intercooler.

As illustrated in FIG. 2, a second gas tank 101b is connected to an air flow downstream side of the intercooler 100. A second intake pipe 102b is connected to an air flow downstream side of the second gas tank 101b. After passing through the intercooler 100 and cooled, the intake air passes through the second gas tank 101b and the second intake pipe 102b in this order. In the following description, the first gas tank 101a and the second gas tank 101b are simply referred to as gas tanks 101a and 101b when distinction between these tanks is not particularly needed.

A throttle valve 103 is disposed at an air flow downstream end inside the second intake pipe 102b to adjust an amount of air introduced into the engine 105. A known intake manifold 104 is connected to an air flow downstream side of the second intake pipe 102b. The engine 105, which is an internal combustion engine generating driving force for traveling of the vehicle 90, is connected to an air flow downstream side of the intake manifold 104. Intake air having passed through the second intake pipe 102b and the intake manifold 104 is introduced into the engine 105.

As illustrated in FIG. 2, the engine room 92 is disposed on a front side of a passenger compartment 108 in a vehicle front-rear direction and on a lower side of an engine hood 109 in a vehicle up-down direction. The first intake pipe 102a, the first gas tank 101a, the intercooler 100, the second gas tank 101b, the second intake pipe 102b, the throttle valve 103, the intake manifold 104, and the engine 105 described above, a radiator 106, and a condenser 107 are disposed inside the engine room 92.

The radiator 106 is a heat exchanger which cools engine cooling water by heat exchange between the engine cooling water and air outside the passenger compartment. The condenser 107 is a heat exchanger which cools a refrigerant of a passenger compartment air conditioner by heat exchange between the refrigerant and air outside the passenger compartment. The passenger compartment air conditioner includes a compressor, the condenser 107, an expansion valve, an evaporator, and others. The refrigerant of the passenger compartment air conditioner is compressed by the compressor, condensed by the condenser 107, decompressed and expanded by the expansion valve, and then is introduced into the evaporator. In the evaporator, heat exchange is conducted between the introduced refrigerant and blown air sent into the passenger compartment. As a result, evaporation of the refrigerant and cooling of the blown air are both achieved.

As illustrated in FIG. 2, the radiator 106 and the condenser 107 are disposed on the vehicle front side of the engine 105. The condenser 107 is disposed on the vehicle front side of the radiator 106.

There is a demand for enlarging the passenger compartment 108 by disposing the engine 105 as close as possible to a front end of the vehicle 90. When the engine 105 is disposed closer to the front end of the vehicle 90, a clearance between the engine 105 and the radiator 106 decreases. Under these conditions, it is preferable that the intercooler 100 is located on the upper side of the engine 105 in the vehicle up-down direction to enhance both heat exchange performance and mountability of the intercooler 100 to a sufficient level. Accordingly, the whole or a part of the intercooler 100 is disposed immediately above the engine 105.

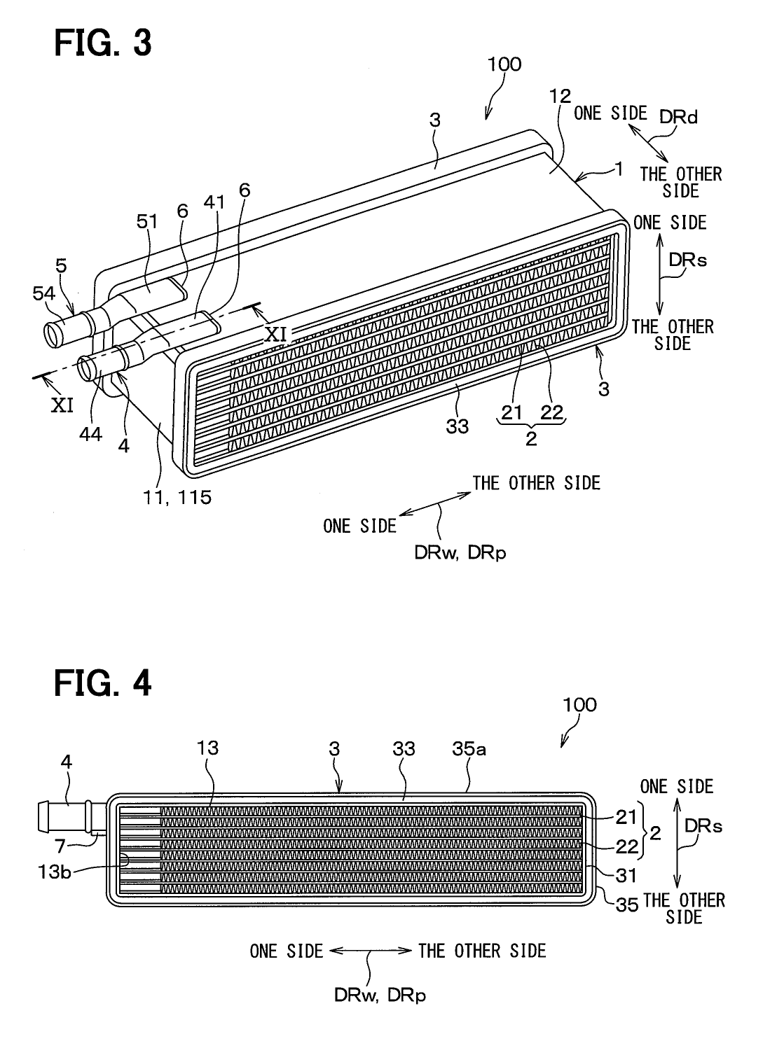

A configuration of the intercooler 100 is hereinafter described. As illustrated in FIGS. 3 to 5, the intercooler 100 includes a duct 1, a laminated core 2, a pair of coupling plates 3, an outlet pipe 4, an inlet pipe 5, two caps 6, and two laminated members 7 as main constituent elements.

As illustrated in FIGS. 3 to 8, the duct 1 has a columnar shape having a rectangular cross section. A duct passage 13 is formed inside the duct 1. Intake air corresponding to first fluid flows from the supercharger SC, and flows through the duct passage 13. The duct 1 is constituted by a first plate 11 and a second plate 12 each made of a thin metal plate, such as an aluminum alloy, molded by press-forming into a predetermined shape.

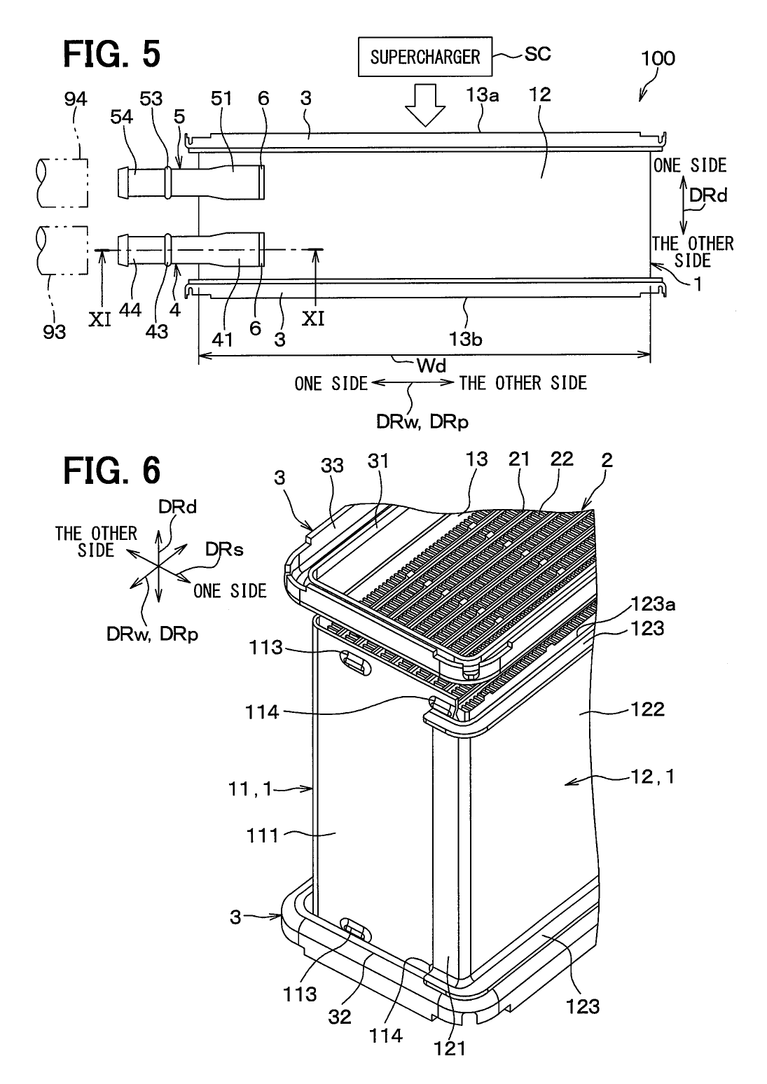

As illustrated in FIGS. 4 and 5, the duct 1 includes an inlet 13a of the duct passage 13 on one side in a duct direction DRd, and an outlet 13b of the duct passage 13 on the other side in the duct direction DRd. The inlet 13a opens to the one side in the duct direction DRd, while the outlet 13b opens to the other side in the duct direction DRd.

Intake air flowing from the supercharger SC enters the inlet 13a of the duct passage 13. Intake air passing through the duct passage 13 flows from the outlet 13b of the duct passage 13. Accordingly, the intake air introduced through the inlet 13a flows from the one side to the other side in the duct direction DRd inside the duct passage 13. The inlet 13a and the outlet 13b of the duct passage 13 are collectively referred to as duct openings 13a and 13b.

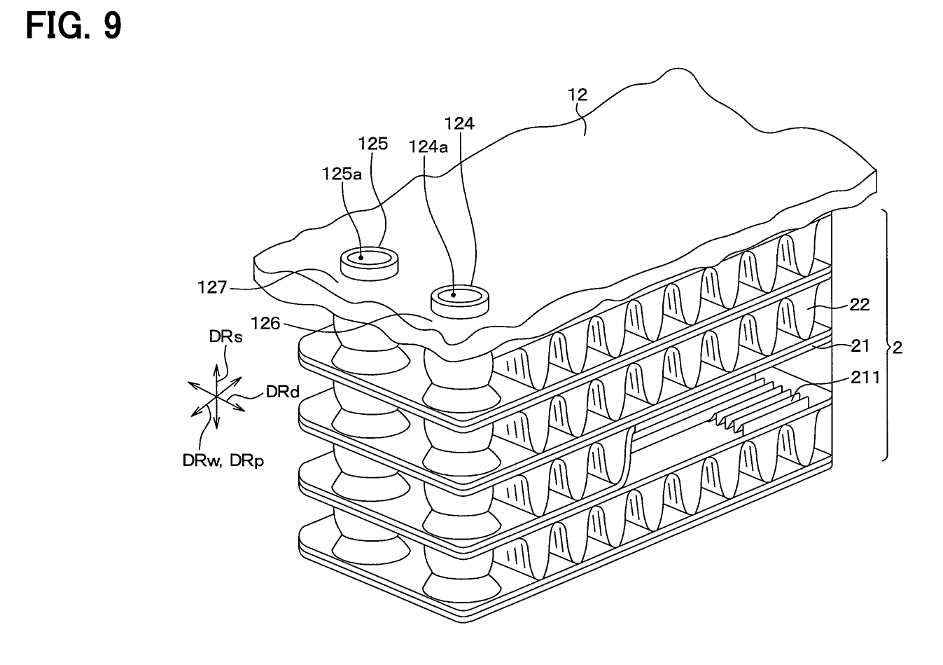

The laminated core 2 is accommodated inside the duct 1. In other words, the duct 1 has the laminated core 2 accommodated in the duct passage 13. As illustrated in FIGS. 4 and 9, the laminated core 2 includes a plurality of cooling tubes 21 laminated in a tube lamination direction DRs. Each of cooling tubes 21 has a flat cross section having a lateral direction coinciding with the tube lamination direction DRs. Cooling fluid flows inside cooling tubes 21 as a second fluid which exchanges heat with intake air passing through the duct passage 13. The cooling tubes 21 cool the intake air by heat exchange between the intake air and the cooling fluid. FIG. 9 does not show the outlet pipe 4, the inlet pipe 5, and the laminated members 7.

Inner fins 211 may be disposed inside each of the cooling tubes 21 to promote heat exchange by increasing heat transfer areas. The cooling tubes 21 are each made of metal such as an aluminum alloy which has a surface cladded in brazing material.

Intake air passes between the cooling tubes 21 adjacent to each other in the laminated core 2. Outer fins 22 are disposed between the adjacent cooling tubes 21 to promote heat exchange by increasing heat transfer areas. The outer fins 22 are each made of a metal thin plate such as an aluminum alloy and molded into a corrugated shape, and joined to the cooling tubes 21 by brazing.

An arrow DRd shown in FIG. 3 indicates the duct direction DRd, an arrow DRs indicates the tube lamination direction DRs, and an arrow DRw indicates a core width direction DRw corresponding to a width direction of the laminated core 2. The duct direction DRd, the tube lamination direction DRs, and the core width direction DRw cross each other, more precisely, cross each other at right angles.

As illustrated in FIGS. 3 to 9, the first plate 11 of the duct 1 includes a pair of first plate end portions 111 and a first plate center portion 112. Each of the pair of first plate end portions 111 is so disposed as to face an end face of the laminated core 2 in the core width direction DRw, and is brazed to the end face of the laminated core 2. Each of the first plate end portions 111 has a plate surface extending in the tube lamination direction DRs. The first plate center portion 112 is so disposed as to face a first end face of the laminated core 2 in the tube lamination direction DRs, and is brazed to the first end face of the laminated core 2. The first plate center portion 112 connects the pair of first plate end portions 111.

The second plate 12 of the duct 1 includes a pair of second plate end portions 121, a second plate center portion 122, and a pair of flange portions 123.

Each of the pair of second plate end portions 121 is so disposed as to face an end face of the laminated core 2 in the core width direction DRw, and has a plate surface extending in the tube lamination direction DRs. Each of the second plate end portions 121 overlaps a part of the corresponding first plate end portion 111 in the core width direction DRw, and is brazed to an outer wall surface of the first plate end portion 111.

The second plate center portion 122 is so disposed to face a second end face of the laminated core 2 in the tube lamination direction DRs to connect the second plate end portions 121, and is brazed to the end face of the laminated core 2. The second end face is an end face opposite to the first end face described above in the tube lamination direction DRs.

The pair of flange portions 123 are located at one and the other ends of the second plate 12 in the duct direction DRd, respectively, and extend in a flange shape from ends of the second plate end portions 121 and the second plate center portion 122 to the outside opposite to the duct passage 13. More specifically, the duct 1 has the flange portions 123 extending in the tube lamination direction DRs, and located at duct end portions 123a which form circumferential edges of the duct openings 13a and 13b, respectively.

Each of the flange portions 123 has a surface which extends in the tube lamination direction DRs when the second plate 12 is assembled to the laminated core 2, the first plate 11, and the coupling plates 3. The flange portions 123 are so disposed as to face the coupling plates 3.

The duct 1, and thereby the duct passage 13 are formed by combining the first plate 11 and the second plate 12. The duct passage 13 is a flow path having a substantially rectangular shape as viewed in the duct direction DRd.

Each of the pair of coupling plates 3 is made of a metal thin plate, such as an aluminum alloy, molded by press-forming into a substantially rectangular frame shape. One of the pair of coupling plates 3 is so formed as to surround the inlet 13a of the duct passage 13, and is brazed to one end of the duct 1. The other of the pair of coupling plates 3 is so formed as to surround the outlet 13b of the duct passage 13, and is brazed to the other end of the duct 1.

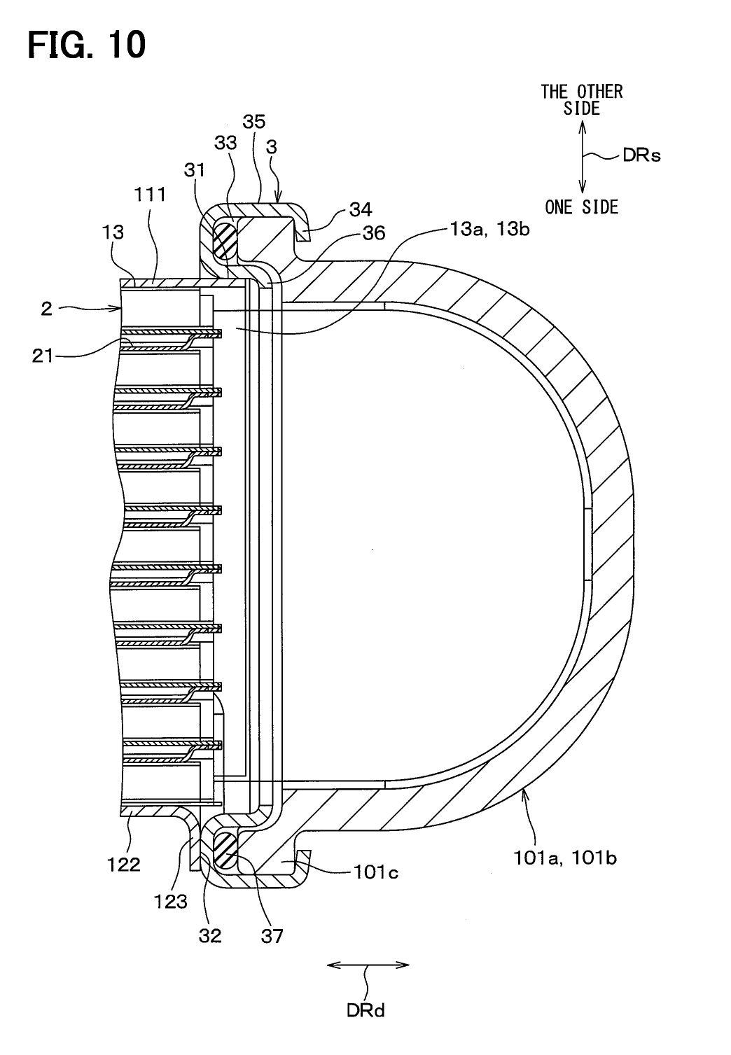

As illustrated in FIG. 10, a groove portion 33 having a U-shaped cross section and opened to the outside of the duct 1 in the duct direction DRd is formed in each of the coupling plates 3. The groove portion 33 has a bottom wall portion 32 forming a bottom of the groove portion 33, an inner circumferential side wall portion 31 raised from an inner circumferential side edge portion of the bottom wall portion 32, and an outer circumferential side wall portion 35 raised from an outer circumferential side edge portion of the bottom wall portion 32. More specifically, the groove portion 33 of the one coupling plate 3 extends along a circumferential edge of the inlet 13a to surround an entire circumference of the inlet 13a of the duct passage 13. The groove portion 33 of the other coupling plate 3 extends along a circumferential edge of the outlet 13b to surround an entire circumference of the outlet 13b of the duct passage 13.

The inner circumferential side wall portions 31 of the coupling plates 3 and an outer wall surface of the first plate 11 are joined by brazing, while the bottom wall portions 32 of the coupling plates 3 and the flange portions 123 of the second plate 12 are joined by brazing.

As illustrated in FIG. 4, each of the coupling plates 3 has one side edge 35a at an end of the coupling plate 3 on one side in the tube lamination direction DRs. The one side edge 35a of each of the coupling plates 3 is a part of the outer circumferential side wall portion 35.

As shown in FIG. 10, a catching portion 36 is formed in each of the coupling plates 3. The catching portion 36 projects toward the duct passage 13 from an end of the inner circumferential side wall portion 31 on the side opposite to the bottom wall portion 32. The catching portion 36 is engageable with the end face of the first plate 11 in the duct direction DRd. The catching portion 36 is provided throughout the circumference of the inner circumferential side wall portion 31.

At the time of assembly of the first plate 11 and the second plate 12 to the coupling plates 3 with the laminated core 2 sandwiched between the first plate 11 and the second plate 12, the first plate 11 enters the inside of the coupling plates 3, whereby the end face of the first plate 11 engages with the catching portion 36. In this manner, projection of the first plate 11 toward the gas tanks 101a and 101b beyond the coupling plates 3 is avoidable.

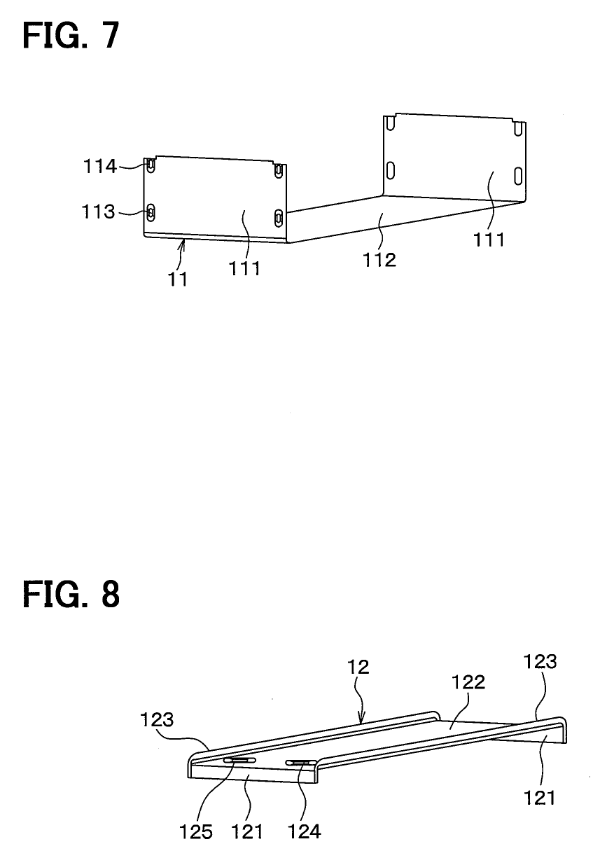

As illustrated in FIGS. 6 and 7, each of the first plate end portions 111 has a positioning projection 113 having a projecting shape and coming into contact with the bottom wall portion 32 of the coupling plate 3. The contact between the positioning projection 113 and the bottom wall portion 32 of the coupling plate 3 determines relative positions of the first plate 11 and the coupling plate 3 in the duct direction DRd at the time of temporary assembly between the first plate 11 and the coupling plate 3.

As illustrated in FIG. 10, outer edges 34 of the coupling plates 3 are caulked on both the inlet 13a side and the outlet 13b side of the duct 1 after a packing 37 and hem portions 101c of the gas tanks 101a and 101b are inserted into the groove portions 33 of the coupling plates 3. In this manner, the coupling plates 3 and the gas tanks 101a and 101b are coupled with each other. Examples of material of the packing 37 adopted herein include acrylic rubber, fluorine rubber, and silicon rubber. Examples of material of the gas tanks 101a and 101b adopted herein include metal such as an aluminum alloy, and resin. The groove portion 33 of each of the coupling plates 3 is formed by press forming, and has an almost flat plate shape with substantially no step formed in the groove portion 33. In this case, compressibility of the packing 37 becomes substantially uniform, wherefore preferable sealing performance is achievable.

As illustrated in FIGS. 6 and 7, each of the first plate end portions 111 includes closing projections 114 each filling a gap produced in a collective portion of the first plate end portion 111, the second plate end portion 121, and the coupling plate 3.

As illustrated in FIGS. 3, 5, and 11, the outlet pipe 4 and the inlet pipe 5 each have the same shape as a single component, and is provided as a common part. The outlet pipe 4 and the inlet pipe 5 are members each molded from a metal pipe such as an aluminum alloy pipe.

Each of the outlet pipe 4 and the inlet pipe 5 is a communication pipe communicating with the plurality of cooling tubes 21 of the laminated core 2. Accordingly, the outlet pipe 4 and the inlet pipe 5 are also collectively referred to as communication pipes 4 and 5. In the description of the present embodiment, the outlet pipe 4 and the inlet pipe 5 are also referred to as the communication pipes 4 and 5 when distinction between the outlet pipe 4 and the inlet pipe 5 is not particularly needed.

The outlet pipe 4 and the inlet pipe 5 are disposed on one side of the laminated core 2 accommodated in the duct 1 in the tube lamination direction DRs. The inlet pipe 5 is disposed on one side of the outlet pipe 4 in the duct direction DRd.

The outlet pipe 4 and the inlet pipe 5 have different functions. More specifically, an inlet hose 94 functioning as an external pipe member is connected to the inlet pipe 5 to introduce cooling fluid into the inlet pipe 5. The inlet pipe 5 guides cooling fluid having entered the inlet pipe 5 from the inlet hose 94 toward the plurality of cooling tubes 21. An outflow hose 93 functioning as an external pipe member is connected to the outlet pipe 4 to discharge cooling fluid from the outlet pipe 4. The outlet pipe 4 guides cooling fluid having entered the outlet pipe 4 from the plurality of cooling tubes 21 toward the outlet hose 93.

As illustrated in FIGS. 4 and 5, the entire outlet pipe 4 and the entire inlet pipe 5 are located on the other side of the one side edge 35a of the coupling plate 3 opposite to the one side in the tube lamination direction DRs.

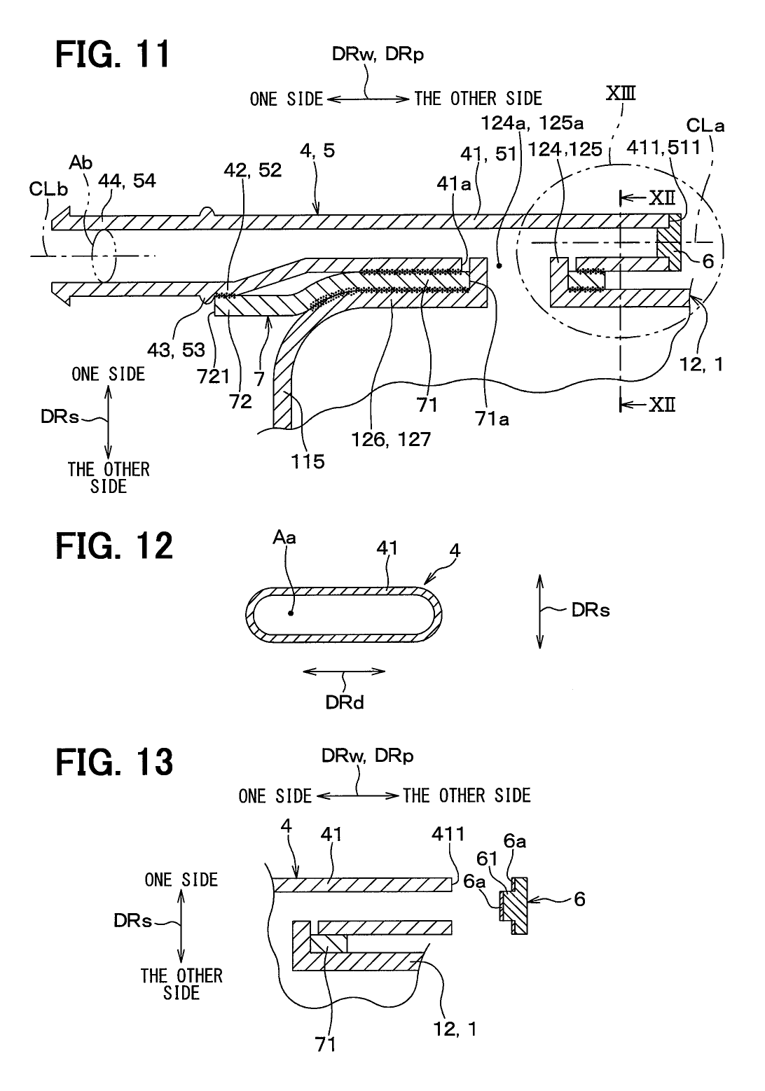

As illustrated in FIGS. 3 and 11, the outlet pipe 4 extends in the pipe extension direction DRp which is a uniaxial direction, and includes a flat pipe portion 41, a pipe joining portion 42, a protrusion 43, and a pipe end portion 44. According to the present embodiment, the pipe extension direction DRp coincides with the core width direction DRw.

The pipe end portion 44, the protrusion 43, the pipe joining portion 42, and the flat pipe portion 41 are disposed in this order from one side in the pipe extension direction DRp. More specifically, the tube joint portion 42 is disposed on the one side of the flat pipe portion 41 in the pipe extension direction DRp, while the pipe end portion 44 is disposed on the one side of the pipe joining portion 42 in the pipe extension direction DRp.

The pipe end portion 44 of the outlet pipe 4 opens to the one side in the pipe extension direction DRp. A region from the pipe end portion 44 to the flat pipe portion 41 is hollow. The outlet hose 93 is connected to the pipe end portion 44, while the flat pipe portion 41 is connected to the plurality of cooling tubes 21. Accordingly, the outlet hose 93 is connected to the plurality of cooling tubes 21 via the outlet pipe 4.

More specifically, as illustrated in FIGS. 11 and 12, the flat pipe portion 41 has a flat cross-sectional shape expanding in a direction crossing the tube lamination direction DRs. According to the present embodiment, for example, a flow path cross-sectional area Ab of a flow path formed inside the pipe end portion 44 is secured also inside the flat pipe portion 41. In other words, a flow path cross-sectional area Aa of a flow path formed inside the flat pipe portion 41 is equal to or larger than the flow path cross-sectional area Ab of the flow path formed inside the pipe end portion 44. The flow path cross-sectional area Aa and the flow path cross-sectional area Ab are flow path cross-sectional areas in a cross section orthogonal to the pipe extension direction DRp which coincides with an axial direction of the flow paths.

A flat pipe communication hole 41a, which is a through hole, is formed in the flat pipe portion 41 on the laminated core 2 side in a lateral direction of the flat cross-sectional shape, i.e., on the other side in the tube lamination direction DRs. The duct 1 has a connecting protrusion 124 which is a part of the second plate 12 and protrudes in a cylindrical shape toward the one side in the tube lamination direction DRs. A duct communication hole 124a is formed inside the connecting protrusion 124. The flat pipe portion 41 communicates with the plurality of cooling tubes 21 via the duct communication hole 124a.

The duct 1 has a duct joining portion 126 disposed around the duct communication hole 124a and joined to the flat pipe portion 41. In other words, the duct joining portion 126 is provided around the connecting protrusion 124. For example, the duct joining portion 126 is so disposed as to surround an entire circumferences of the duct communication hole 124a and the connecting protrusion 124.

The duct joining portion 126 is a part of the second plate 12. Accordingly, as illustrated in FIGS. 4 and 11, the one side edge 35a of the coupling plate 3 is located on the one side of the duct joining portion 126 in the tube lamination direction DRs.

As illustrated in FIGS. 5 and 11, the duct joining portion 126 is disposed at a position on the one side in the pipe extension direction DRp in a range Wd occupied by the duct 1 in the pipe extension direction DRp.

As illustrated in FIG. 11, each of the flat pipe portion 41 and the pipe end portion 44 of the outlet pipe 4 contains a flow path extending in the pipe extension direction DRp. Accordingly, the flat pipe portion 41 and the tube distal end portion 44 have center axes CLa and CLb, respectively, extending in the pipe extension direction DRp. The center axis CLa of the flat pipe portion 41 is located on one side of the center axis CLb of the pipe end portion 44 in the tube lamination direction DRs.

The flat pipe portion 41 has an opposite end 411 on the side opposite to the pipe end portion 44, i.e., on the other side in the pipe extension direction DRp. The cap 6 is joined to the opposite end 411 of the flat pipe portion 41. The opposite end 411 is airtightly closed by the cap 6. The cap 6 has a cap protrusion 61 protruding toward the one side in the pipe extension direction DRp. The cap protrusion 61 is fitted into the flat pipe portion 41. For example, as illustrated in FIG. 13, the cap 6 is made of metal such as an aluminum alloy, and is constituted by a clad member which has a flat pipe portion 41 side surface cladded in a brazing material layer 6a. The cap 6 is brought into close contact with the opposite end 411 of the flat pipe portion 41, and is temporarily heated. In this manner, the cap 6 is brazed to the opposite end 411.

As illustrated in FIG. 11, the protrusion 43 of the outlet pipe 4 protrudes radially outward from the outlet pipe 4. The protrusion 43 also extends throughout the circumference of the outlet pipe 4 to form an annular shape.

As illustrated in FIG. 11 and FIGS. 14 to 16, each of the laminated members 7 is a member molded from a metal plate made of an aluminum alloy or the like.

The laminated member 7 is constituted by a plate member having brazing material on both surfaces of the laminated member 7 as a single part before brazing. More specifically, the laminated member 7 is constituted by a plate-shaped clad member both surfaces of which are cladded in brazing material.

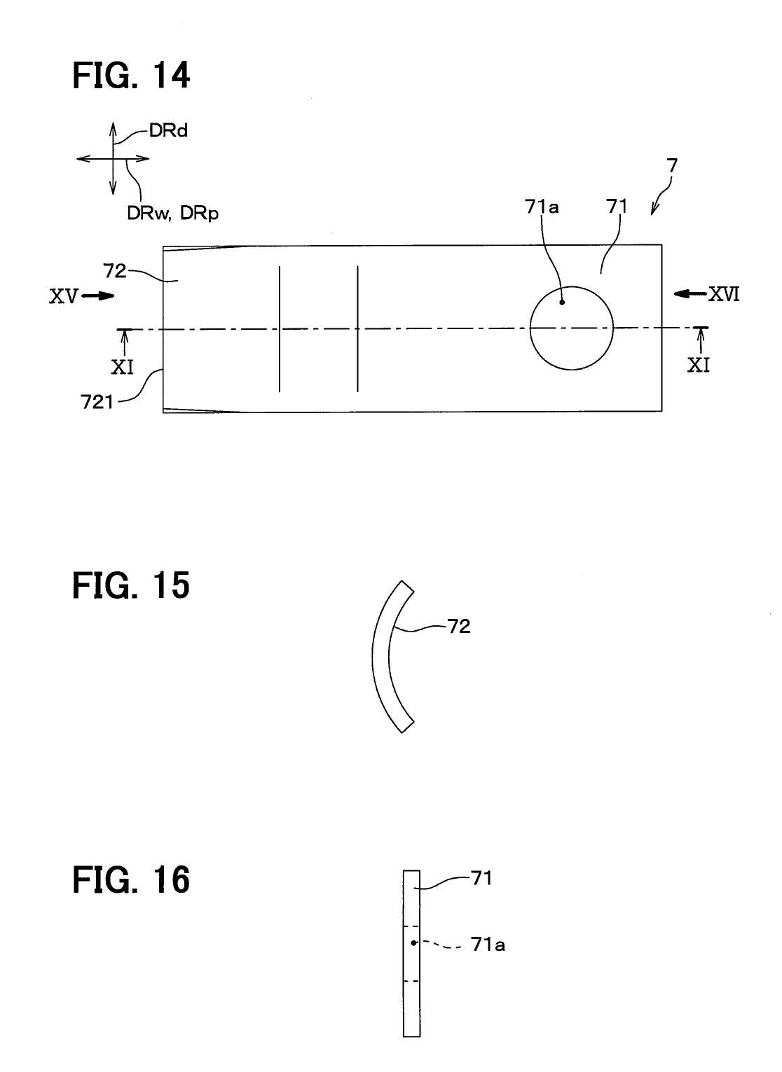

When the cladded brazing material is melted and then solidified, each of the laminated members 7 of the intercooler 100 is brazed to members adjacent to the laminated member 7 (more specifically, duct 1 and communication pipes 4 and 5). In FIG. 11, the laminated member 7 at a portion subjected to brazing is point-hatched. The laminated member 7 shown in FIG. 11 also corresponds to a cross section taken along a line XI-XI in FIG. 14.

The laminated member 7 includes a laminated plate portion 71 and a supporting portion 72. The laminated member 7 is made of one plate member, wherefore the laminated plate portion 71 and the supporting portion 72 are formed integrally with each other. The supporting portion 72 is located on one side of the laminated plate portion 71 in the pipe extension direction DRp. The supporting portion 72 has a distal end 721 on one side in the pipe extension direction DRp.

The supporting portion 72 of the laminated member 7 has a shape following an external shape of the pipe joining portion 42 of the outlet pipe 4. More specifically, the supporting portion 72 is curved in such a shape as to have an arcuate cross section following the external shape of the pipe joining portion 42. The supporting portion 72 is disposed on the other side of the pipe joining portion 42 of the outlet pipe 4 in the tube lamination direction DRs, and is joined to the pipe joining portion 42. In addition, the distal end 721 of the supporting portion 72 abuts on the protrusion 43 of the outlet pipe 4 from the other side in the pipe extension direction DRp. More specifically, the supporting portion 72 of the laminated member 7 is joined to a portion of the outlet pipe 4 other than the flat pipe portion 41. In this manner, the laminated member 7 supports the outlet pipe 4.

As illustrated in FIGS. 3, 6, and 11, the duct 1 has a one side duct wall portion 115 facing the duct passage 13 from the one side in the pipe extension direction DRp. The one side duct wall portion 115 is constituted by portions included in the pair of first plate end portions 111 and the pair of second plate end portions 121 and disposed on one side of the duct passage 13 in the pipe extension direction DRp. The supporting portion 72 of the laminated member 7 is located on one side in the pipe extension direction DRp with respect to the one side duct wall portion 115.

The laminated plate portion 71 of the laminated member 7 is disposed between the flat pipe portion 41 of the outlet pipe 4 and the duct joining portion 126 of the duct 1, and laminated in close contact with each of the flat pipe portion 41 and the duct joining portion 126.

The laminated plate portion 71 thus laminated is joined to each of the flat pipe portion 41 and the duct joining portion 126. In this manner, the duct joining portion 126 is joined to the flat pipe portion 41 with the laminated plate portion 71 interposed therebetween. More specifically, the flat pipe portion 41 is disposed on the one side of the duct 1 in the tube lamination direction DRs, and is joined to the duct 1.

The connecting protrusion 124 of the duct 1 is fitted into a through hole 71a formed in the laminated plate portion 71.

The inlet pipe 5 has a configuration similar to the configuration of the outlet pipe 4 described above, wherefore the inlet pipe 5 is only briefly described herein. As illustrated in FIGS. 3, 5, and 11, the inlet pipe 5 also includes a flat pipe portion 51, a pipe joining portion 52, a protrusion 53, and a pipe end portion 54 similarly to the outlet pipe 4. The flat pipe portion 51 of the inlet pipe 5 is similar to the flat pipe portion 41 of the outlet pipe 4. The pipe joining portion 52 of the inlet pipe 5 is similar to the pipe joining portion 42 of the outlet pipe 4. The protrusion 53 of the inlet pipe 5 is similar to the protrusion 43 of the outlet pipe 4. The pipe end portion 54 of the inlet pipe 5 is similar to the pipe end portion 44 of the outlet pipe 4.

However, the inlet hose 94 is connected to the pipe end portion 54 of the inlet pipe 5. FIG. 11 is a cross-sectional view of the outlet pipe 4. In FIG. 11, reference numerals of parts of the inlet pipe 5 are also given after reference numerals of the corresponding parts of the outlet pipe 4 in correspondence with each other.

As illustrated in FIGS. 9 and 11, a duct communication hole 125a communicating with the flat pipe portion 51 of the inlet pipe 5, and a connecting protrusion 125 forming the duct communication hole 125a are similar to the duct communication hole 124a communicating with the flat pipe portion 41 of the outlet pipe 4 and the connecting protrusion 124 forming the duct communication hole 124a, respectively. The duct 1 includes a duct joining portion 127 joined to the flat pipe portion 51 of the inlet pipe 5. The duct joining portion 127 is similar to the duct joining portion 126 joined to the flat pipe portion 41 of the outlet pipe 4.

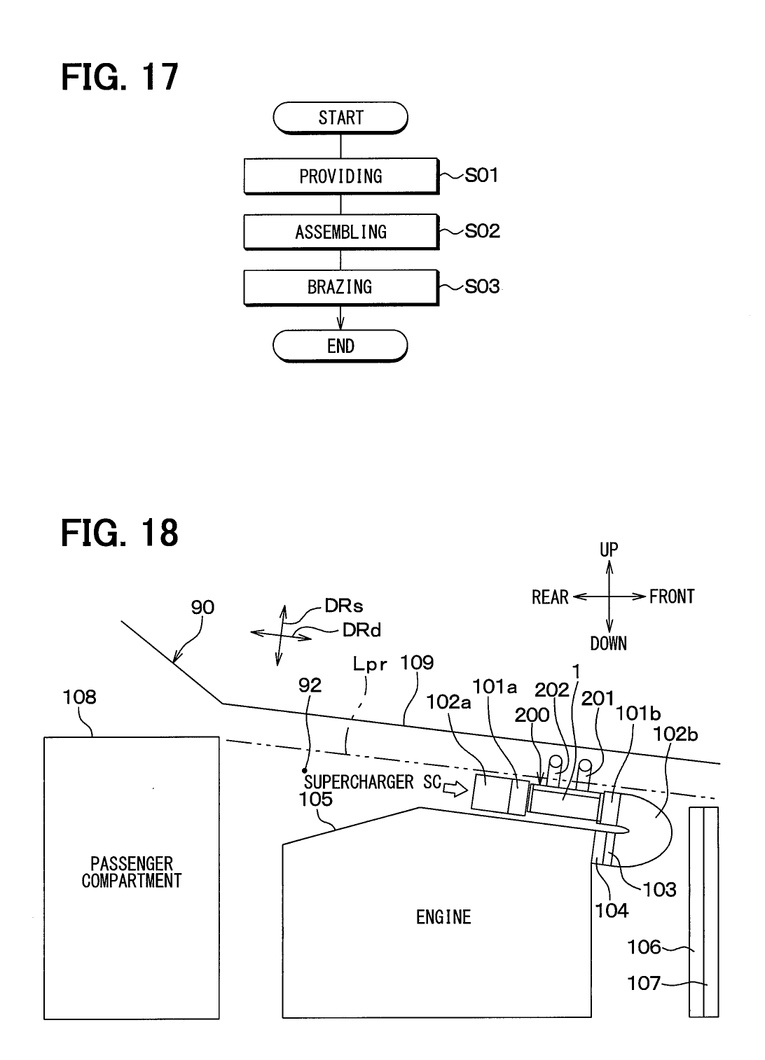

Manufacture of the intercooler 100 configured as described above proceeds as shown in a flowchart of FIG. 17. For manufacturing the intercooler 100, the duct 1, the laminated core 2, the coupling plates 3, the outlet pipe 4, the inlet pipe 5, the caps 6, and the laminated members 7 constituting the intercooler 100 are initially prepared in step S01 corresponding to a preparation step.

More specifically, parts prepared in step S01 are parts before brazing. Accordingly, in step 501, the constituent parts of the duct 1, the constituent parts of the laminated core 2, the coupling plates 3, the outlet pipe 4, the inlet pipe 5, the caps 6, and the laminated members 7, each prior to brazing, are prepared. For example, the constituent parts of the duct 1 are the first plate 11, the second plate 12, and others before brazing, while the constituent parts of the laminated core 2 are a plurality of parts constituting the cooling tubes 21, the outer fins 22, and others before brazing. The order of preparing the respective constituent parts is not particularly limited. Moreover, all the constituent parts may be simultaneously prepared.

Subsequently, in step S02 corresponding to an assembly step, the respective parts prepared in step S01 are temporarily assembled. In other words, in step S02, the constituent parts of the duct 1, the constituent parts of the laminated core 2, the coupling plates 3, the outlet pipe 4, the inlet pipe 5, the caps 6, and the laminated members 7 are temporarily assembled to constitute an intercooler temporary assembly.

For example, in the intercooler temporary assembly, the outlet pipe 4 and the inlet pipe 5 as the communication pipes 4 and 5 are disposed such that the pipe extension direction DRp crosses each of the tube lamination direction DRs and the duct direction DRd, more precisely, crosses these directions at right angles. Concerning the communication pipes 4 and 5, the flat pipe portions 41 and 51 communicate with the plurality of cooling tubes 21 via the duct communication holes 124a and 125a formed in the duct 1. In addition, the flat pipe portions 41 and 51 are laminated on one side of the laminated plate portions 71 in the tube lamination direction DRs, while the duct joining portions 126 and 127 are laminated on the other side of the laminated plate portions 71 in the tube lamination direction DRs.

In this temporary assembly state, the respective components of the intercooler temporary assembly are held by a not-shown jig or the like to come into close contact with each other at brazing portions.

Subsequently, in step S03 corresponding to a brazing process, the intercooler temporary assembly is temporarily heated in a furnace to braze the respective components of the intercooler temporary assembly to each other. For example, at the outlet pipe 4 and the inlet pipe 5, the flat pipe portions 41 and 51 are brazed to the duct joining portions 126 and 127 with the laminated plate portions 71 of the laminated members 7 interposed therebetween by the brazing material applied to the surface of the laminated members 7 as clad material. In addition, the pipe joining portions 42 and 52 are brazed to the supporting portions 72 of the laminated members 7 by the brazing materials of the laminated members 7.

According to the present embodiment, as described above, the flat pipe portion 41 of the outlet pipe 4 has a flat cross-sectional shape expanding in a direction crossing the tube lamination direction DRs as illustrated in FIG. 11. The flat pipe portion 51 of the inlet pipe 5 has a similar configuration. Accordingly, the outlet pipe 4 and the inlet pipe 5 can be configured such that the projecting widths of the outlet pipe 4 and the inlet pipe 5 to the one side in the tube lamination direction DRs are reduced. An increase in the overall width of the intercooler 100 in the tube lamination direction DRs can be therefore reduced even in the presence of the outlet pipe 4 and the inlet pipe 5.

In other words, the configuration which includes the communication pipes 4 and 5 each having a flat shape and disposed on the duct 1 can reduce projection of the communication pipes 4 and 5, functioning as cooling water pipes, in the tube lamination direction DRs, and improve mountability of the intercooler 100 around the engine 105.

The intercooler 100 which reduces an increase in the overall width in the tube lamination direction DRs even in the presence of the outlet pipe 4 and the inlet pipe 5 can be manufactured as shown in the flowchart of FIG. 17.

Each of the laminated members 7 according to the present embodiment is constituted by a clad member as a single component before brazing. Both surfaces of the clad member are cladded in brazing material. If brazing material for brazing is provided not on the laminated members 7 but on the surface of the duct 1 in advance unlike this configuration, the brazing material once melted and solidified remains on the surface of the duct 1 after brazing. In this case, the external appearance of the intercooler 100 deteriorates. If the brazing material is provided not on the laminated members 7 but on the surfaces of the communication pipes 4 and 5 in advance in a different example, the brazing material once melted and solidified also remains on the surfaces of the pipe end portions 44 and 54 included in the communication pipes 4 and 5 after brazing. In this case, the external pipe members 93 and 94 are difficult to connect to the pipe end portions 44 and 54 in a preferable condition. In addition, the clad member cladded in brazing material and provided on the outer surfaces of the pipes is not generally used.

In contrast, according to the method for manufacturing the intercooler 100 of the present embodiment, the laminated member 7 before brazing is constituted by a plate member having brazing material on both surfaces. The flat pipe portions 41 and 51 of the communication pipes 4 and 5 are brazed to the duct joining portions 126 and 127 with the laminated plate portions 71 of the laminated members 7 interposed therebetween. Accordingly, the flat pipe portions 41 and 51 of the communication pipes 4 and 5 can be brazed to the duct joining portions 126 and 127 in such a manner as not to deteriorate the external appearance of the intercooler 100 and preferable connectivity of the external pipe members 93 and 94 to the pipe end portions 44 and 54.

As described above, the laminated plate portions 71 of the laminated members 7 are essential components for brazing the communication pipes 4 and 5 to the duct 1, wherefore the laminated members 7 are not regarded as components additionally required for providing the communication pipes 4 and 5. As illustrated in FIG. 11, the laminated members 7 also have a reinforcing function for reinforcing the communication pipes 4 and 5 by brazing between the supporting portions 72 and the pipe joining portions 42 and 52 of the communication pipes 4 and 5. More specifically, the cross-sectional coefficients of the communication pipes 4 and 5 partially decrease due to flattening, wherefore flexural rigidity of these pipes lowers. According to the present embodiment, however, the communication pipes 4 and 5 can be reinforced by a simple configuration without the necessity of additional parts. Accordingly, sufficient rigidity of the communication pipes 4 and 5 can be secured. In short, brazing between the communication pipes 4 and 5 and the duct 1, and securing the rigidity of the communication pipes 4 and 5 are both achievable.

According to the present embodiment, the flat pipe portions 41 and 51 included in the communication pipes 4 and 5 and provided on the duct 1 each have a flat cross-sectional shape. The communication pipes 4 and 5 are each so formed as to extend in the pipe extension direction DRp crossing the tube lamination direction DRs. Accordingly, projection of pipe in the tube lamination direction DRs decreases, wherefore preferable mountability of the intercooler 100 on the vehicle 90 is achievable.

According to the present embodiment, the flat pipe portions 41 and 51 of the communication pipes 4 and 5 are disposed on the one side of the duct 1 in the tube lamination direction DRs, and joined to the duct 1 as illustrated in FIG. 11. The duct communication holes 124a and 125a are formed in the duct 1. The duct 1 has the duct joining portions 126 and 127 disposed around the respective duct communication holes 124a and 125a and joined to the flat pipe portions 41 and 51. The flat pipe portions 41 and 51 communicate with the plurality of cooling tubes 21 via the duct communication holes 124a and 125a, respectively. This configuration can form the duct 1, and join the communication pipes 4 and 5 to the surface of the duct 1.

According to the present embodiment, the duct joining portions 126 and 127 are joined to the flat pipe portions 41 and 51 with the laminated plate portions 71 of the laminated members 7 interposed therebetween by junction between the laminated plate portions 71 and the flat pipe portions 41 and 51 of the communication pipes 4 and 5 and junction between the laminated plate portions 71 and the duct joining portions 126 and 127. The pipe joining portions 42 and 52 included in the communication pipes 4 and 5 and joined to the supporting portions 72 of the laminated members 7 are disposed on the one side in the pipe extension direction DRp with respect to the flat pipe portions 41 and 51, while the pipe end portions 44 and 54 are disposed on the one side in the pipe extension direction DRp with respect to the pipe joining portions 42 and 52. Accordingly, the communication pipes 4 and 5 extending in the pipe extension direction DRp can be reinforced by the laminated members 7.

According to the present embodiment, the flow path cross-sectional area Aa of the flow path formed in each of the flat pipe portions 41 and 51 of the communication pipes 4 and 5 is equivalent to or larger than the flow path cross-sectional area Ab of the flow path formed in each of the pipe end portions 44 and 54 as illustrated in FIGS. 11 and 12. Accordingly, a pressure loss of cooling fluid caused by the flat cross-sectional shapes of the flat pipe portions 41 and 51 can decrease.

According to the present embodiment, the center axis CLa of the flat pipe portions 41 and 51 of the communication pipes 4 and 5 is located on the one side of the center axis CLb in the tube lamination direction DRs with respect to the pipe end portions 44 and 54 as illustrated in FIG. 11. Accordingly, an increase in the width of the intercooler 100 toward the one side in the tube lamination direction DRs by the presence of the tube distal end portions 44 and 54 of the communication pipes 4 and 5 can be reduced in comparison with a configuration which includes the flat pipe portions 41 and 51 coaxial with the pipe end portions 44 and 54, for example.

According to the present embodiment, the duct 1 has the one side duct wall portion 115 facing the duct passage 13 from the one side in the pipe extension direction DRp. The supporting portion 72 of the laminated member 7 is located on the one side in the pipe extension direction DRp with respect to the one side duct wall portion 115. Accordingly, this configuration supports the communication pipes 4 and 5 in an appropriate condition with the laminated members 7 while allowing the pipe end portions 44 and 54 of the communication pipes 4 and 5 to project from the duct 1 toward the one side in the pipe extension direction DRp.

According to the present embodiment, the distal ends 721 of the supporting portions 72 of the laminated members 7 abut on the protrusions 43 and 53 of the communication pipes 4 and 5 from the other side opposite to the one side in the pipe extension direction DRp. Accordingly, deflection of the communication pipes 4 and 5 into a bent shape can be reduced also by the abutment between the distal ends 721 of the supporting portions 72 and the protrusions 43 and 53 of the communication pipes 4 and 5.

According to the present embodiment, the duct 1 includes the flange portions 123 extending in the tube lamination direction DRs and provided at the duct end portions 123a forming the circumferential edges of the duct openings 13a and 13b as illustrated in FIGS. 6 and 10. Each of the flange portions 123 is joined to the bottom wall portion 32 forming the bottom of the groove portion 33 of the coupling plate 3. Accordingly, the junction portion between the duct 1 and the coupling plate 3 has a structure capable of absorbing a dimensional change of the laminated core 2 at the time of brazing.

According to the present embodiment, each of the coupling plates 3 has the one side edge 35a at the end on the one side in the tube lamination direction DRs as shown in FIGS. 4 and 11. Each of the entire communication pipes 4 and 5 is positioned on the other side opposite to the one side in the tube lamination direction DRs with respect to the one side edge 35a of the coupling plate 3. Accordingly, projection of the communication pipes 4 and 5 toward the one side in the tube lamination direction DRs is avoidable.

This point is herein described with reference to FIGS. 2 and 18. FIG. 18 is a view corresponding to FIG. 2 of the present embodiment, illustrating a state that an intercooler 200 of a comparative example compared with the present embodiment is provided inside the engine room 92. The intercooler 200 of the comparative example has two pipes 201 and 202 in place of the communication pipes 4 and 5 of FIG. 2. More specifically, the two pipes 201 and 202 are connected to the duct 1 in such a manner as to project from the duct 1 to the one side in the tube lamination direction DRs, and bent such that a pipe end faces to the one side in the core width direction DRw. The intercooler 200 of the comparative example is similar to the intercooler 100 of the present embodiment, except that the communication pipes 4 and 5 are replaced with the two pipes 201 and 202.

According to the intercooler 200 of the comparative example, the two pipes 201 and 202 considerably project to the one side in the tube lamination direction DRs from an intercooler body constituted by the duct 1, the laminated core 2, and the coupling plates 3 as illustrated in FIG. 18. Accordingly, even if the intercooler body is disposed on the lower side of a pedestrian protection line Lpr in the vehicle up-down direction, for example, the two pipes 201 and 202 project upward from the pedestrian protection line Lpr.

The pedestrian protection line Lpr is an imaginary line virtually formed to protect a head of a pedestrian when the vehicle 90 collides with the pedestrian, and is disposed on the lower side in the vehicle up-down direction with a predetermined clearance left between the pedestrian protection line Lpr and the engine hood 109. It is preferable that substantially no constituent part of the vehicle 90 be provided between the pedestrian protection line Lpr and the engine hood 109 within the engine room 92.

According to the intercooler 100 of the present embodiment, not only the intercooler main body but also the two communication pipes 4 and 5 can be easily limited to the region of the lower side of the pedestrian protection line Lpr in the vehicle up-down direction as illustrated in FIG. 2. In other words, upward projection of only the two communication pipes 4 and 5 of the intercooler 100 in the vehicle up-down direction beyond the pedestrian protection line Lpr is avoidable. From this point of view, mountability of the intercooler 100 into the engine room 92 of the present embodiment improves in comparison with the intercooler 200 of the comparative example, for example.

### Second Embodiment

A second embodiment is now described. In the present embodiment, points different from the first embodiment described above are chiefly described. Description of parts identical or equivalent to corresponding parts in the above embodiment is omitted or simplified. This omission or simplification is also applicable to description of embodiments presented below.

The present embodiment is different from the first embodiment in the positions of the brazing material for brazing the flat pipe portions 41 and 51 of the outlet pipe 4 and the inlet pipe 5 to the caps 6.

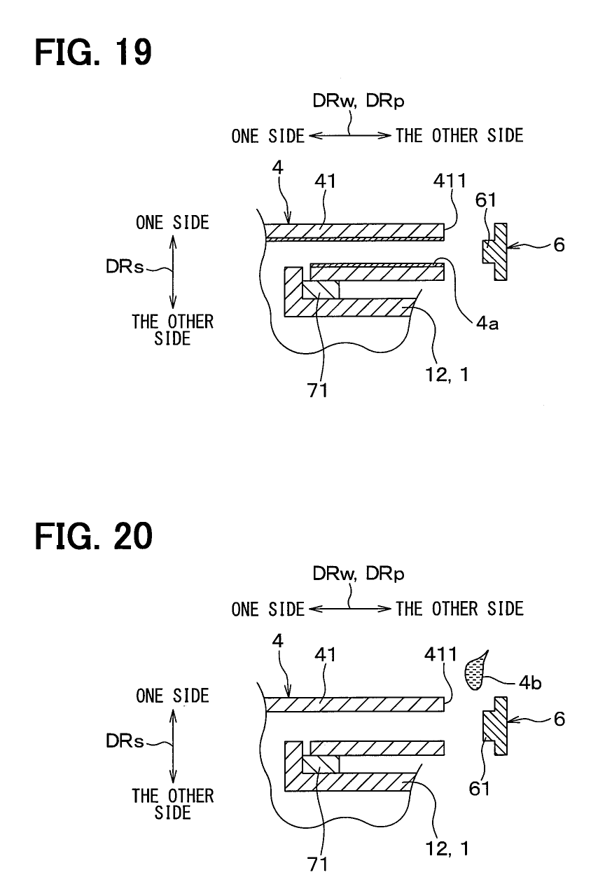

More specifically, as illustrated in FIG. 19, the cap 6 is not constituted by a clad member. Instead, the outlet pipe 4 is constituted by a clad member which has a brazing material layer 4a inside as clad material. The cap 6 is brought into close contact with the opposite end 411 of the flat pipe portion 41, and is temporarily heated. In this manner, an inner circumferential surface of the flat pipe portion 41 is brazed to an outer circumferential surface of the cap protrusion 61. Accordingly, the opposite end 411 of the flat pipe portion 41 is airtightly closed by the cap 6.

The cap 6 is joined to the inlet pipe 5 in a manner similar to the manner of junction between the cap 6 and the outlet pipe 4 as described above.

Except for the points described above, the present embodiment is similar to the first embodiment. According to the present embodiment, advantageous effects similar to those of the first embodiment can be produced by a configuration common to the configuration of the first embodiment.

### Third Embodiment

A third embodiment is now described. In the present embodiment, points different from the first embodiment described above are chiefly described.

The present embodiment is different from the first embodiment in the method for supplying the brazing material for brazing the flat pipe portions 41 and 51 of the outlet pipe 4 and the inlet pipe 5 to the caps 6.

More specifically, as illustrated in FIG. 20, the cap 6 is not constituted by a clad member. Instead, a brazing material 4b is supplied between the opposite end 411 of the flat pipe portion 41 and the cap 6 at the time of brazing between the flat pipe portion 41 of the outlet pipe 4 and the cap 6. For example, the brazing material 4b is applied to either the opposite end 411 of the flat pipe portion 41 or the cap 6. The cap 6 pressed against the opposite end 411 of the flat tube portion 41 is temporarily heated. As a result, the cap 6 is brazed to the opposite end 411 of the flat pipe portion 41. Accordingly, the opposite end 411 of the flat pipe portion 41 is airtightly closed by the cap 6.

The cap 6 is joined to the inlet pipe 5 in a manner similar to the manner of junction between the cap 6 and the outlet pipe 4 as described above.

Except for the points described above, the present embodiment is similar to the first embodiment. According to the present embodiment, advantageous effects similar to those of the first embodiment can be produced by a configuration common to the configuration of the first embodiment.

### Fourth Embodiment

A fourth embodiment is now described. In the present embodiment, points different from the first embodiment described above are chiefly described.

The present embodiment is different from the first embodiment in the method for closing the opposite ends 411 and 511 of the flat pipe portions 41 and 51 of the outlet pipe 4 and the inlet pipe 5. In the present embodiment, the cap 6 of the first embodiment is not used.

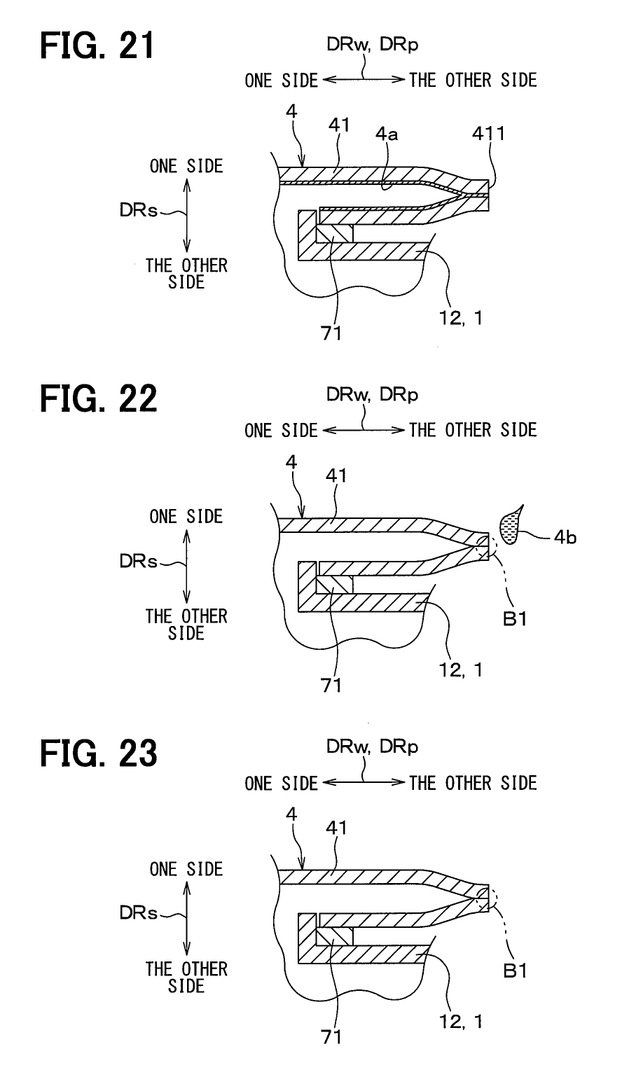

More specifically, the outlet pipe 4 is constituted by a clad member which has a brazing material layer 4a inside the outlet pipe 4 as clad material as illustrated in FIG. 21. The opposite end 411 of the flat pipe portion 41 is crushed in the tube lamination direction DRs, whereby the opposite end 411 of the flat pipe portion 41 is closed. The opposite end 411 of the flat pipe portion 41 crushed in this manner is temporarily heated, whereby the opposite end 411 is airtightly closed by brazing the inner circumferential surface of the flat pipe portion 41 at the opposite end 411.

The method for closing the opposite end 511 of the flat pipe portion 51 of the inlet pipe 5 is similar to the method for closing the opposite end 411 of the flat pipe portion 41 of the outlet pipe 4 described above.

Except for the points described above, the present embodiment is similar to the first embodiment. According to the present embodiment, advantageous effects similar to those of the first embodiment can be produced by a configuration common to the configuration of the first embodiment.

### Fifth Embodiment

A fifth embodiment is now described. In the present embodiment, points different from the first embodiment described above are chiefly described.

The present embodiment is different from the first embodiment in the method for closing the opposite ends 411 and 511 of the flat pipe portions 41 and 51 of the outlet pipe 4 and the inlet pipe 5. In the present embodiment, the cap 6 of the first embodiment is not used.

More specifically, at the time of brazing, the brazing material 4b is applied to the inner circumferential surface of the flat pipe portion 41 at the opposite end 411 of the flat pipe portion 41 of the outlet pipe 4. In addition, the opposite end 411 of the flat pipe part 41 is crushed in the tube lamination direction DRs as illustrated in FIG. 22. In this manner, the opposite end 411 of the flat pipe portion 41 is closed. The opposite end 411 of the flat pipe portion 41 crushed in this manner is temporarily heated, whereby the opposite end 411 is airtightly closed by brazing the inner circumferential surface of the flat pipe portion 41 at the opposite end 411. For example, the opposite end 411 of the flat pipe portion 41 is airtightly closed by the brazing material 4b applied to a portion B1 in FIG. 22.

The method for closing the opposite end 511 of the flat pipe portion 51 of the inlet pipe 5 is similar to the method for closing the opposite end 411 of the flat pipe portion 41 of the outlet pipe 4 described above.

Except for the points described above, the present embodiment is similar to the first embodiment. According to the present embodiment, advantageous effects similar to those of the first embodiment can be produced by a configuration common to the configuration of the first embodiment.

### Sixth Embodiment

A sixth embodiment is now described. In the present embodiment, points different from the first embodiment described above are chiefly described.

The present embodiment is different from the first embodiment in the method for closing the opposite ends 411 and 511 of the flat pipe portions 41 and 51 of the outlet pipe 4 and the inlet pipe 5. In the present embodiment, the cap 6 of the first embodiment is not used.

More specifically, as illustrated in FIG. 23, the opposite end 411 of the flat pipe portion 41 of the outlet pipe 4 is crushed in the tube lamination direction DRs, whereby the opposite end 411 of the flat pipe portion 41 is closed. The opposite end 411 of the flat pipe portion 41 is crushed in this manner, and then the inner circumferential surface of the flat pipe portion 41 is welded at the other end 411. As a result, the opposite end 411 is airtightly closed. For example, the opposite end 411 of the flat pipe portion 41 is airtightly closed by welding a portion B1 in FIG. 23.

The method for closing the opposite end 511 of the flat pipe portion 51 of the inlet pipe 5 is similar to the method for closing the opposite end 411 of the flat pipe portion 41 of the outlet pipe 4 described above.

Except for the points described above, the present embodiment is similar to the first embodiment. According to the present embodiment, advantageous effects similar to those of the first embodiment can be produced by a configuration common to the configuration of the first embodiment.

### Other Embodiments

(1) In the respective embodiments described above, the inlet pipe 5 is disposed on the one side in the duct direction DRd with respect to the outlet pipe 4 as illustrated in FIG. 3. However, the outlet pipe 4 may be disposed on the one side in the duct direction DRd with respect to of the inlet pipe 5.

(2) In the respective embodiments described above, the pipe extension direction DRp coincides with the core width direction DRw as illustrated in FIG. 5.

However, the pipe extension direction DRp is not required to coincide with the core width direction DRw as long as the pipe extension direction DRp crosses the tube lamination direction DRs and the duct direction DRd.

(3) In the respective embodiments described above, the outlet pipe 4 is brazed to the duct 1 with the laminated member 7 interposed therebetween as illustrated in FIG. 11. However, this junction may be made by welding, caulking, or other joining methods instead of brazing. Moreover, the outlet pipe 4 may be directly joined to the duct 1 without using the laminated member 7. These points are also applicable to the inlet pipe 5.

(4) In the respective embodiments described above, the outlet pipe 4 is brazed to the duct 1 with the laminated member 7 interposed therebetween. The laminated member 7 before brazing is constituted by a clad member having brazing material on both surfaces as clad material as illustrated in FIG. 11. However, this configuration is presented only by way of example. For example, the laminated member 7 before brazing may be constituted by a clad member having brazing material only on the outlet pipe 4 side surface, while the second plate 12 of the duct 1 before brazing may be constituted by a clad member having brazing material only on the laminated member 7 side surface. In this case, the laminated member 7 and the outlet pipe 4 are brazed to each other by the brazing material applied to the laminated member 7 as clad material. Also, the second plate 12 and the laminated member 7 are brazed to each other by the brazing material applied to the second plate 12 as clad material.

(5) In the respective embodiments described above, the duct joining portion 126 of the duct 1 is so provided as to surround the entire circumferences of the duct communication hole 124a and the connecting protrusion 124 as illustrated in FIG. 11. However, this configuration is presented only by way of example. For example, such a configuration may be considered that the duct joining portion 126 does not surround the entire circumferences of the duct communication hole 124a and the connecting protrusion 124. This configuration is also applicable to the other duct joining portion 127.

In a different example, the outlet pipe 4 before brazing may be constituted by a clad member having brazing material only on the laminated member 7 side surface, while the laminated member 7 before brazing may be constituted by a clad member having brazing material only on the second plate 12 side surface of the duct 1. In this case, the laminated member 7 and the outlet pipe 4 are brazed to each other by the brazing material applied to the outlet pipe 4 as clad material. In addition, the second plate 12 and the laminated member 7 are brazed to each other by the brazing material applied to the laminated member 7 as clad material. These points are also applicable to the inlet pipe 5.

(6) The present disclosure is not limited to the embodiments described above, but may be practiced with various modifications. Needless to say, the elements constituting the respective embodiments described above are not necessarily essential unless clearly expressed as particularly essential, or considered as obviously essential in principle, for example.

Values such as numbers of the constituent elements, numerical values, quantities, and ranges in the respective embodiments are not limited to the specific values described herein unless clearly expressed as particularly essential, or considered as obviously limited to the specific values in principle, for example. The materials, shapes, positional relationships, or other conditions of the constituent elements and the like described in the respective embodiments are not limited to specific materials, shapes, positional relationships, or other conditions unless clearly expressed, or limited to the specific materials, shapes, positional relationships, or other conditions in principle.

### Conclusion

According to a first aspect described in a part or all of the above embodiments, an intercooler includes a laminated core having a plurality of cooling tubes laminated in a tube lamination direction. The intercooler further includes a communication pipe disposed on one side of the laminated core in the tube lamination direction, and communicating with the plurality of cooling tubes. Cooling fluid which exchanges heat with supercharged intake air flows inside the plurality of cooling tubes. The communication pipe has a flat pipe portion connected to the plurality of cooling tubes. The flat pipe portion has a flat cross-sectional shape expanding in a direction crossing the tube lamination direction.

According to a second aspect, the flat pipe portion is disposed on one side of a duct in the tube lamination direction, and is joined to the duct. A duct communication hole is formed in the duct. The duct includes a duct joining portion joined to the flat pipe portion and disposed around the duct communication hole. The flat pipe portion communicates with the plurality of cooling tubes via the duct communication hole. This configuration can form the duct, and join the communication pipe to the surface of the duct.

According to a third aspect, the duct joining portion is joined to the flat pipe portion with a laminated plate portion interposed therebetween by junction between the laminated plate portion to each of the flat pipe portion and the duct joining portion. The pipe joining portion included in the communication pipe and joined to the supporting portion of the laminated member are disposed on the one side in the pipe extension direction with respect to the flat pipe portion, while the pipe end portion is disposed on the one side in the pipe extension direction with respect to the pipe joining portion. Accordingly, the communication pipe extending in the pipe extension direction can be reinforced by the laminated member.

According to a fourth aspect, a flow path cross-sectional area of a flow path formed in the flat pipe portion is equal to or larger than a flow path cross-sectional area of a flow path formed in the pipe end portion. Accordingly, a pressure loss of cooling fluid caused by the flat cross-sectional shape of the flat pipe portion can decrease.

According to a fifth aspect, a center axis of the flat pipe portion included in the communication pipe is located on the one side in the tube lamination direction with respect to a center axis of the pipe end portion . Accordingly, an increase in the width of the intercooler toward the one side in the tube lamination direction by the presence of the pipe end portion of the communication pipe can be reduced.

According to a sixth aspect, the duct has a one side duct wall portion facing the duct passage from the one side in the pipe extension direction. The supporting portion of the laminated member is located on the one side in the pipe extension direction with respect to the one side duct wall portion. Accordingly, this configuration can support the communication pipe in an appropriate condition with the laminated member while allowing the pipe end portion of the communication pipe to project from the duct toward the one side in the pipe extension direction.

According to a seventh aspect, the distal end of the supporting portion of the laminated member abuts on the protrusion of the communication pipe from the other side opposite to the one side in the pipe extension direction. Accordingly, deflection of the communication pipe into a bent shape can be reduced also by the abutment between the distal end of the supporting portion and the protrusion of the communication pipe.

According to an eighth aspect, the duct has a flange portion extending in the tube lamination direction and located at a duct end portion forming a circumferential edge of a duct opening. The flange portion is joined to a wall portion forming a bottom of a groove portion of a coupling plate. Accordingly, the junction portion between the duct and the coupling plate has a structure capable of absorbing a dimensional change of the laminated core at the time of brazing.

According to a ninth aspect, the coupling plate has a one side edge at an end on one side in the tube lamination direction. The entire communication pipe is located on the other side opposite to the one side in the tube lamination direction with respect to the one side edge of the coupling plate. Accordingly, projection of the communication pipe toward the one side in the tube lamination direction is avoidable.

According to a tenth aspect, in a method for manufacturing an intercooler, the communication pipe is disposed such that the pipe extension direction crosses the tube lamination direction and the duct direction and the flat portion communicates with the cooling tubes through the duct communication hole of the duct. The flat pipe portion is disposed on one side of the laminated plate portion in the tube lamination direction, and a duct joining portion of the duct surrounding the duct communication hole is disposed on the other side of the laminated plate portion in the tube lamination direction. After the laminating, bonding the pipe joining portion to the supporting portion, and the flat pipe portion to the duct joining portion through the laminated plate portion by temporarily heating the duct, the communication pipe, and the laminated member to braze with the brazing material.

What is claimed is:

1. An intercooler for cooling supercharged intake air supplied to an internal combustion engine via a supercharger, the intercooler comprising:
a laminated core that includes a plurality of cooling tubes laminated in a tube lamination direction;
a communication pipe disposed on one side of the laminated core in the tube lamination direction and communicating with the plurality of cooling tubes;
a duct that defines a duct passage through which the supercharged intake air flows, the duct passage accommodating the laminated core; and
a laminated member, wherein
cooling fluid that exchanges heat with the supercharged intake air flows through the plurality of cooling tubes,
the communication pipe includes a flat pipe portion connected to the plurality of cooling tubes,
the flat pipe portion has a flat cross-sectional shape extending in a direction crossing the tube lamination direction,
the flat pipe portion is disposed on the one side of the duct in the tube lamination direction and joined to the duct,
the duct has a duct communication hole,
the duct includes a duct joining portion joined with the flat pipe portion and disposed around the duct communicating hole,
the flat pipe portion communicates with the plurality of cooling tubes via the duct communication hole,
the laminated member includes
a laminated plate portion disposed between the flat pipe portion and the duct joining portion, the laminated plate portion being laminated on each of the flat pipe portion and the duct joining portion, and
a supporting portion formed integrally with the laminated plate portion,
the duct includes
an inlet of the duct passage on one side in a duct direction crossing the tube lamination direction, the supercharged intake air flowing into the duct passage through the inlet, and
an outlet of the duct passage on another side in the duct direction, the supercharged intake air being discharged from the duct passage through the outlet,
the communication pipe includes
a pipe joining portion joined to the supporting portion, and
a pipe end portion connected to an external pipe member through which the cooling fluid flows into the communication pipe or the cooling fluid flows out of the communication pipe,
the communication pipe extends in a pipe extension direction crossing the tube lamination direction and the duct direction,
the laminated plate portion is joined to the flat pipe portion and the duct joining portion, and thereby the duct joining portion is connected to the flat pipe portion through the laminated plate portion,
the pipe joining portion is located on one side in the pipe extension direction with respect to the flat pipe portion, and
the pipe end portion is disposed on the one side in the pipe extension direction with respect to the pipe joining portion.

2. The intercooler according to claim 1, wherein
a flow path cross-sectional area of a flow path defined in the flat pipe portion is equal to or larger than a flow path cross-sectional area of a flow path defined in the pipe end portion.

3. The intercooler according to claim 1, wherein
each of the flat pipe portion and the pipe end portion has a center axis extending in the pipe extension direction, and
the center axis of the flat pipe portion is located on the one side in the tube lamination direction with respect to the center axis of the pipe end portion.

4. The intercooler according to claim 1, wherein
the duct has a one side duct wall portion that faces the duct passage from one side in the pipe extension direction, and
the supporting portion is located on the one side in the pipe extension direction with respect to the one side duct wall portion.

5. The intercooler according to claim 1, wherein
the communication pipe includes a protrusion that protrudes radially outward from the communication pipe,
the supporting portion has a distal end on the one side in the pipe extension direction, and
the distal end of the supporting portion abuts on the protrusion of the communication pipe from another side opposite to the one side in the pipe extension direction.

6. The intercooler according to claim 1, further comprising
a coupling plate that includes a groove portion extending along a circumferential edge of a duct opening that is either the inlet or the outlet to surround the duct opening, the coupling plate being joined to the duct, wherein
the duct opening is open in the duct direction,
the duct includes a flange portion that extends in the tube lamination direction and is disposed at a duct end portion forming a circumferential edge of the duct opening, and
the flange portion is joined to a wall portion that forms a bottom of the groove portion.

7. The intercooler according to claim 1, further comprising
a coupling plate surrounding a duct opening that is either the inlet or the outlet, wherein
the coupling plate has a one side edge at an end on the one side in the tube lamination direction,
the one side edge of the coupling plate is located on the one side in the tube lamination direction with respect to the duct joining portion, and
the communication pipe is entirely located on another side opposite to the one side in the tube lamination direction with respect to the one side edge of the joining plate.

8. A method for manufacturing an intercooler that includes:
a laminated core that includes a plurality of cooling tubes laminated in a tube lamination direction, cooling fluid flowing through the plurality of cooling tubes, the cooling fluid exchanging heat with supercharged intake air supplied to an internal combustion engine via a supercharger, the laminated core cooling the supercharged intake air by heat exchange between the supercharged intake air and the cooling fluid; and
a duct that defines a duct passage through which the supercharged intake air flows from one side to another side in a duct direction crossing the tube lamination direction, the duct passage accommodating the laminated core, the method comprising:
preparing the duct;
preparing a communication pipe that extends in a pipe extension direction and includes
a flat pipe portion having a flat cross-sectional shape,
a pipe end portion disposed on one side in the pipe extension direction with respect to the flat pipe portion and connected to an external pipe member, and
a pipe joining portion located between the flat pipe portion and the pipe end portion in the pipe extension direction;
preparing a laminated member that is a plate member having a brazing material on both sides and includes
a laminated plate portion, and
a supporting portion formed integrally with the laminated plate portion;
laminating the communication pipe, the laminated member, and the duct such that
the pipe extension direction crosses the tube lamination direction and the duct direction,
the flat pipe portion communicates with the plurality of cooling tubes through a duct communication hole of the duct,
the flat pipe portion is disposed on one side of the laminated plate portion in the tube lamination direction,
a duct joining portion of the duct surrounding the duct communication hole is disposed on another side of the laminated plate portion in the tube lamination direction; and
after the laminating, bonding the pipe joining portion to the supporting portion, and the flat pipe portion to the duct joining portion through the laminated plate portion by temporarily heating the duct, the communication pipe, and the laminated member to braze with the brazing material.
